(19) United States
(12) Patent Application Publication
(10) Pub. No.: US 2024/0241743 A1
(43) Pub. Date: Jul. 18, 2024

(54) REGISTRATION AND DEPLOYMENT OF AN AGENT PLATFORM APPLIANCE IN A HYBRID ENVIRONMENT

(71) Applicant: VMware, Inc., Palo Alto, CA (US)

(72) Inventors: Prateek GUPTA, San Francisco, CA (US); Fnu YASHU, Sunnyvale, CA (US)

(21) Appl. No.: 18/156,331

(22) Filed: Jan. 18, 2023

(51) Int. Cl. G06F 9/455

(52) U.S. Cl. CPC G06F 9/45558; G06F 2009/45583; G06F 2009/45587; G06F 2009/45595

(57) ABSTRACT

A method of registering and deploying an agent platform appliance in a hybrid environment includes the steps of: transmitting a first code to a cloud platform to create an authentication account for the agent platform appliance, wherein credentials for accessing the authentication account include the first code; transmitting a request for an access token that permits downloading images of agents from an agent repository of the cloud platform, wherein the request for the access token includes the first code for accessing the created authentication account; upon receiving the access token, transmitting a request to the agent repository, to download the images of the agents, wherein the request to download the images of the agents includes the received access token; and upon receiving the images of the agents from the agent repository, installing the agents on the agent platform appliance using the received images of the agents.

### BACKGROUND

In a software-defined data center (SDDC), virtual infrastructure, which includes virtual machines (VMs) and virtualized storage and networking resources, is provisioned from hardware infrastructure that includes a plurality of host servers, storage devices, and networking devices. The provisioning of the virtual infrastructure is carried out by SDDC management software that is deployed on management appliances, such as a VMware vCenter Server® appliance and a VMware NSX® appliance, available from VMware, Inc. The SDDC management software manages the virtual infrastructure by communicating with virtualization software (e.g., a hypervisor) installed in the host servers.

It has become common for multiple SDDCs to be deployed across multiple clusters of host servers. Each cluster is a group of host servers that are managed together by the management software to provide cluster-level functions, such as load balancing across the cluster through VM migration between the host servers, distributed power management, dynamic VM placement according to affinity and anti-affinity rules, and high availability (HA). The management software also manages a shared storage device to provision storage resources for the cluster from the shared storage device, and manages a software-defined network through which the VMs communicate with each other.

For some customers, their SDDCs are deployed across different geographical regions and may even be deployed in a hybrid manner. A hybrid cloud is one in which applications are running in a combination of different environments, e.g., on-premise, in a public cloud, and/or as a service. “SDDCs deployed on-premise” means that the SDDCs are provisioned in a private data center that is controlled by a particular organization. “SDDCs deployed in a public cloud” means that the SDDCs of a particular organization are provisioned in a public data center along with SDDCs of other organizations. “SDDCs deployed as a service” means that the SDDCs are provided to the organization as a service on a subscription basis. As a result, for SDDCs deployed as a service, the organization does not need to carry out management operations on the SDDCs such as configuring, upgrading, and patching, and the availability of the SDDCs is provided according to a service-level agreement (SLA) of the subscription.

With a large number of SDDCs, monitoring and performing operations on the SDDCs through interfaces, e.g., application programming interfaces (APIs), provided by the management software, and managing the lifecycle of the management software, have proven to be challenging. Conventional techniques for managing the SDDCs and the management software of the SDDCs are not practicable when there is a large number of SDDCs, especially when they are spread out across multiple geographical locations and in a hybrid manner.

### SUMMARY

One or more embodiments provide a cloud platform from which various services, referred to herein as “cloud services,” are delivered to SDDCs. The cloud services are delivered through agents of the cloud services that are running in an appliance, referred to herein as an “agent platform (AP) appliance.” The cloud platform is a computing platform that hosts containers or VMs corresponding to the cloud services delivered from the cloud platform. The AP appliance is deployed in the same customer environment, e.g., a private data center, as management appliances of the SDDCs.

Embodiments are depicted herein in a hybrid environment because the cloud platform is provisioned in a public cloud, and the AP appliance and the SDDCs are provisioned in the customer environment (e.g., a private data center). Because the cloud platform and the AP appliance are in different computing environments, the two communicate over a public network such as the Internet. On the other hand, the AP appliance and the management appliances of the SDDCs communicate with each other over a private physical network, e.g., a local area network (LAN). Examples of cloud services that are delivered include an SDDC configuration service, an SDDC upgrade service, an SDDC monitoring service, an SDDC inventory service, and a message broker service. Each of these cloud services has a corresponding agent installed on the AP appliance. All communication between the cloud services and the management software of the SDDCs is carried out through the AP appliance, for example, through agents of the cloud services installed on the AP appliance.

Embodiments provide a method of registering and deploying an AP appliance in a hybrid environment. The method includes the steps of: transmitting a first code to a cloud platform to create an authentication account for the AP appliance, wherein credentials for accessing the authentication account include the first code; transmitting a request for an access token that permits downloading images of agents from an agent repository of the cloud platform, wherein the request for the access token includes the first code for accessing the created authentication account; upon receiving the access token, transmitting a request to the agent repository, to download the images of the agents, wherein the request to download the images of the agents includes the received access token; and upon receiving the images of the agents from the agent repository, installing the agents on the AP appliance using the received images of the agents.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of customer environments of different organizations that are managed through a multi-tenant cloud platform implemented in a public cloud.

FIG. 2A is a block diagram of a single customer environment and the public cloud, illustrating the downloading of AP appliance bits for installation in the customer environment.

FIG. 2B is a block diagram of the customer environment and the public cloud, illustrating a first step of registering the AP appliance by creating credentials for an authentication account and requesting a code from the cloud platform.

FIG. 2C is a block diagram of the customer environment and the public cloud, illustrating a second step of registering the AP appliance by receiving the code from the cloud platform.

FIG. 2D is a block diagram of the customer environment and the public cloud, illustrating a final step of registering the AP appliance by transmitting the credentials and the code to the cloud platform for an authentication account to be created for the AP appliance.

FIG. 3A is a block diagram of the customer environment and the public cloud, illustrating a first step of deploying the AP appliance by acquiring an access token from the cloud platform.

FIG. 3B is a block diagram of the customer environment and the public cloud, illustrating a second step of deploying the AP appliance by downloading a desired state manifest of the AP appliance from the cloud platform.

FIG. 3C is a block diagram of the customer environment and the public cloud, illustrating a final step of deploying the AP appliance by downloading images of agents from the cloud platform and installing the agents on AP appliance.

FIG. 4 is a flow diagram of a method performed by a host server in the customer environment and the cloud platform, to register the AP appliance with the cloud platform, according to an embodiment.

FIG. 5 is a flow diagram of a method performed by the host server and the cloud platform to install a coordinator agent on the AP appliance, according to an embodiment.

FIG. 6 is a flow diagram of a method performed by the host server and the cloud platform to install additional agents on the AP appliance, according to an embodiment.

### DETAILED DESCRIPTION

Techniques for registering an AP appliance with a cloud platform and deploying the AP appliance in a hybrid environment, are described. As used herein, “registering” the AP appliance is the process of creating an authentication account for the AP appliance. “Deploying” the AP appliance is the process of installing agents on the AP appliance to connect management appliances of the hybrid environment to cloud services executing on a cloud platform.

To register the AP appliance, trust is first established between the AP appliance and the cloud platform through the transmission of codes between the AP appliance and the cloud platform. Once trust is established, an authentication service creates an authentication account for the AP appliance based on which the cloud platform issues access tokens to the AP appliance. The access tokens permit communication with cloud services of the cloud platform, e.g., to request downloads of a desired state of the AP appliance and images of agents specified by the desired state of the AP appliance.

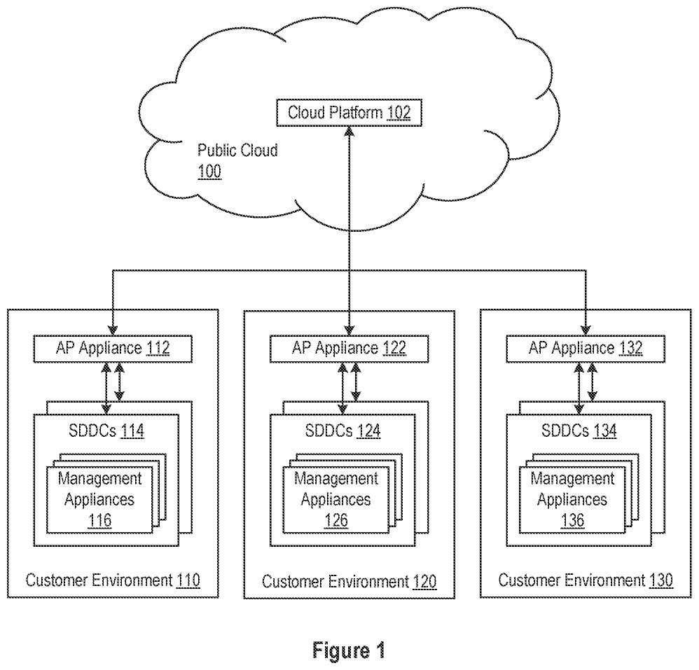

FIG. 1 is a block diagram of customer environments 110, 120, and 130 of different organizations (also referred to as “customers”). The customer environments are managed through a multi-tenant cloud platform 102 implemented in a public cloud 100. A plurality of SDDCs is illustrated in each of the customer environments, including SDDCs 114 in customer environment 110, SDDCs 124 in customer environment 120, and SDDCs 134 in customer environment 130. As used herein, a “customer environment” means one or more private data centers managed by the customer, which is commonly referred to as “on-premise,” a private cloud managed by the customer, a public cloud managed for the customer by another organization, or any combination of these. In addition, the SDDCs of any one customer may be deployed in a hybrid manner, e.g., on-premise, in a public cloud, and/or as a service, and across different geographical regions.

In each customer environment, the SDDCs are managed by respective management appliances, including management appliances 116 of SDDCs 114, management appliances 126 of SDDCs 124, and management appliances 136 of SDDCs 134. The management appliances of each of the customer environments include a virtual infrastructure management (VIM) server (e.g., a VMware vCenter Server® appliance, available from VMware, Inc.) for overall management of virtual infrastructure of respective SDDCs. The management appliances of each of the customer environments further include a network management server (e.g., a VMware NSX® appliance, available from VMware, Inc.) for management of virtual networks of respective SDDCs.

The management appliances in each of the customer environments communicate with a respective AP appliance, including an AP appliance 112 in customer environment 110, an AP appliance 122 in customer environment 120, and an AP appliance 132 in customer environment 130. Agents (not shown in FIG. 1) are installed on each of the AP appliances, and the agents communicate with cloud platform 102 to deliver cloud services to respective customer environments. In some embodiments, each of the AP appliances and each of the management appliances are a VM instantiated on one or more physical host servers. In other embodiments, any of the AP appliances and the management appliances may be implemented as physical host servers. The AP appliances illustrated in FIG. 1 have already been registered with cloud platform 102 and deployed in respective customer environments. The registration and deployment of AP appliances will be discussed below.

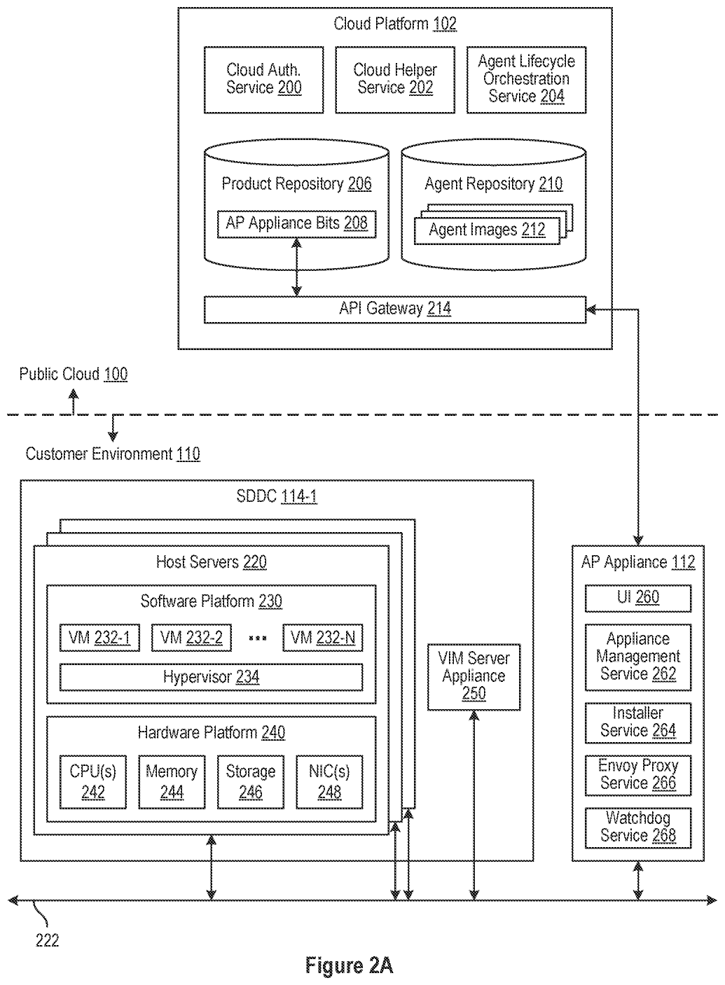

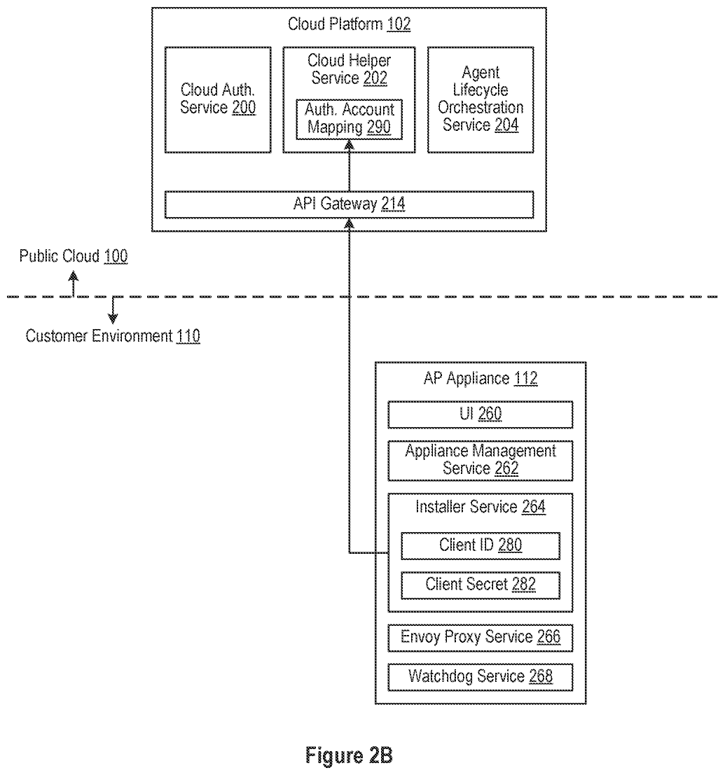

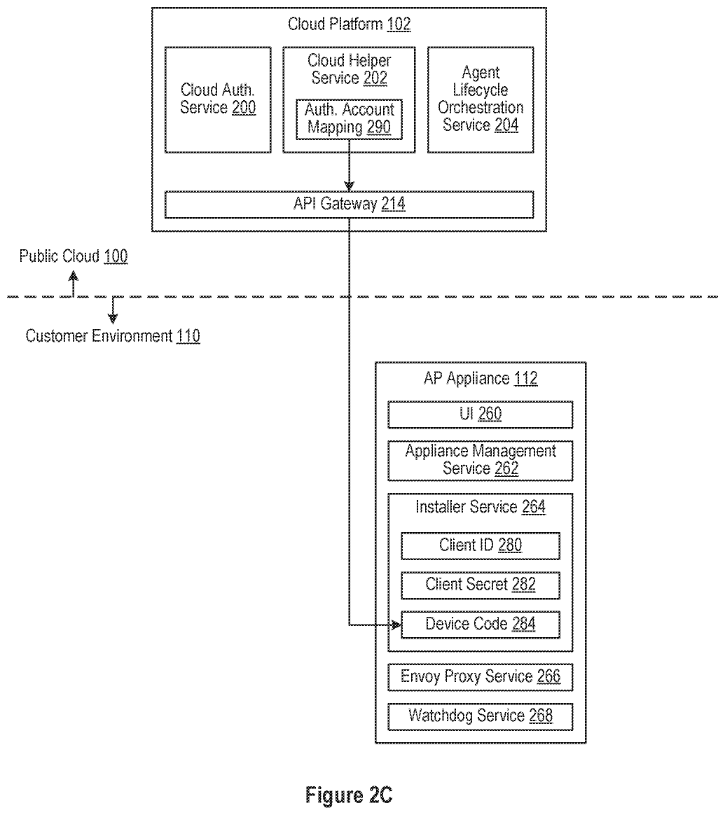

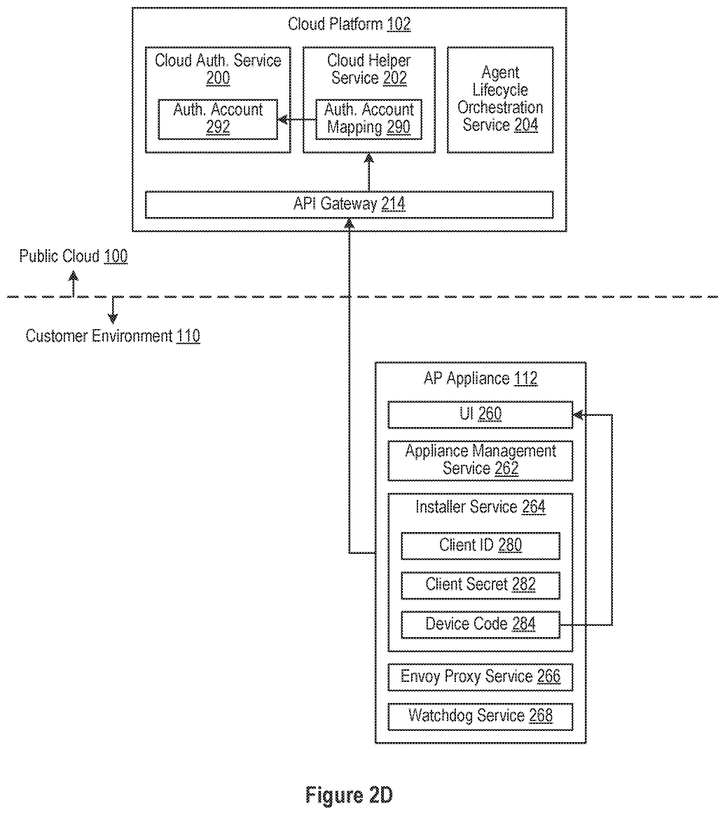

FIG. 2A is a block diagram of customer environment 110 and public cloud 100, illustrating the downloading of AP appliance bits 208 for installation in customer environment 110. Customer environment 110 includes an SDDC 114-1, which includes a plurality of host servers 220 and a VIM server appliance 250. Each of host servers 220 is constructed on a server grade hardware platform 240 such as an x86 architecture platform.

Hardware platform 240 includes conventional components of a computing device, such as one or more central processing units (CPUs) 242, memory 244 such as random-access memory (RAM), storage 246 such as one or more magnetic drives or solid-state drives (SSDs) and/or a host bus adapter for connecting to a storage area network, and one or more network interface cards (NICs) 248. NIC(s) 248 enable host servers 220 to communicate with each other and with other devices over a physical network 222. Physical network 222 is distinguishable from a public network such as the Internet through which cloud platform 102 communicates with devices of customer environment 110. Physical network 222 is a private network, e.g., a LAN or a sub-net, and is partitioned from the public network through a firewall.

Hardware platform 240 of each of host servers 220 supports a software platform 230. Software platform 230 includes a hypervisor 234, which is a virtualization software layer. Hypervisor 234 supports a VM execution space within which VMs 232 are concurrently instantiated and executed. One example of hypervisor 234 is a VMware ESX® hypervisor, available from VMware, Inc. VIM server appliance 250 logically groups host servers 220 into a cluster to perform cluster-level tasks such as provisioning and managing VMs 232 and migrating VMs 232 from one of host servers 220 to another. VIM server appliance 250 communicates with host servers 220 via a management network (not shown) provisioned from physical network 222. VIM server appliance 250 may be, e.g., a physical server or one of VMs 232.

Public cloud 100 is operated by a cloud computing service provider from a plurality of physical host severs (not shown). Cloud platform 102 includes cloud services such as a cloud authentication service 200, a cloud helper service 202, an agent lifecycle orchestration service 204, and other cloud services (not shown). Such other cloud services include an SDDC configuration service, an SDDC upgrade service, an SDDC monitoring service, an SDDC inventory service, and a message broker service. In one embodiment, each of the cloud services of cloud platform 102 is a microservice that is implemented as one or more container images executed on a virtual infrastructure of public cloud 100. Devices of customer environment 110 communicate with the cloud services by making API calls such as Java API calls via an API gateway 214.

Cloud helper service 202 performs operations to establish trust with AP appliances, as discussed further below. Agent lifecycle orchestration service 204 maintains desired states (not shown) to share with the AP appliances. Such desired states include lists of agents to install on the AP appliances. Cloud authentication service 200 enables authentication with cloud helper service 202, agent lifecycle orchestration service 204, and the other cloud services.

To enable such authentication, cloud authentication service 200 issues access tokens such as JavaScript Object Notation (JSON) web tokens (JWTs). Each access token allows a requesting party to communicate with a cloud service via API gateway 214. It should be noted that although cloud authentication service 200 is illustrated as being within cloud platform 102, cloud authentication service 200 may run on a virtual or physical server that is not part of cloud platform 102 but that is still accessible to cloud platform 102. For security purposes, access tokens each have a specified time-to-live (TTL) after which the tokens expire.

Cloud platform 102 includes a product repository 206 and an agent repository 210. Product repository 206 stores bits for software that may be installed in customer environments, including AP appliance bits 208. For example, AP appliance bits 208 may be stored as an ISO file. Agent repository 210 stores images of agents to be installed on AP appliances, such as Docker® container images. When one of host servers 220 triggers the registration and deployment of an AP appliance, host server 220 transmits a request to product repository 206 via API gateway 214 for AP appliance bits 208. For example, an administrator of an organization may trigger the registration and deployment. Upon receiving the request, product repository 206 transmits AP appliance bits 208 to host server 220 for installation thereon of AP appliance 112.

AP appliance bits 208 include code for executing a user interface (UI) 260 through which the administrator interacts with AP appliance 112. AP appliance bits 208 further include code for executing various services that are used throughout the registration and deployment of AP appliance 112. Accordingly, upon installation of AP appliance 112 from AP appliance bits 208, AP appliance 112 includes UI 260, an appliance management service 262, an installer service 264, an envoy proxy service 266, and a watchdog service 268. For example, these services may be packaged within AP appliance bits 208 as RPM files. It should be noted that installer service 264 installs and starts envoy proxy service 266, and then installer service 264 installs and starts watchdog service 268. The functionalities of these services are discussed further below.

In embodiments described herein, AP appliance 112 is one of VMs 232. However, in other embodiments, AP appliance 112 may be implemented as a physical host server such as one of host servers 220 or may be implemented via other types of virtual computing instances such as containers, Docker® containers, data compute nodes, and isolated user space instances.

FIG. 2B is a block diagram of customer environment 110 and public cloud 100, illustrating a first step of registering AP appliance 112. Installer service 264 generates a random client identifier (ID) 280 and a random client secret 282. Client ID 280 and client secret 282 are credentials for an authentication account to be created for AP appliance 112. Client ID 280 identifies AP appliance 112, and client secret 282 is a code associated with client ID 280. Before an authentication account is created for AP appliance 112, trust is first established between AP appliance 112 and cloud platform 102 to prevent an authentication account from being created for a fraud.

To establish trust, installer service 264 begins by transmitting an API request to cloud helper service 202 via API gateway 214 for a code, referred to herein as a “device code.” The request includes client ID 280 and client secret 282 in an encrypted header of the request. Upon receiving the request, cloud helper service 202 generates a random device code (not shown in FIG. 2B) such as a six-digit number. Cloud helper service 202 then stores a mapping between the generated device code, client ID 280, and client secret 282 in memory (not shown) of cloud helper service 202 as authentication account mapping 290.

FIG. 2C is a block diagram of customer environment 110 and public cloud 100, illustrating a second step of registering AP appliance 112. Cloud helper service 202 transmits the device code of authentication account mapping 290 to installer service 264, which installer service 264 stores as device code 284. It should be noted that device code 284 has a limited TTL after which device code 284 expires. Accordingly, to successfully establish trust with cloud platform 102, installer service 264 will transmit device code 284 back to cloud helper service 202 before the TTL expires.

FIG. 2D is a block diagram of customer environment 110 and public cloud 100, illustrating a final step of registering AP appliance 112. Installer service 264 transmits device code 284 to UI 260 to be displayed to the administrator. The administrator then logs in to an account on cloud platform 102 that the administrator previously created, and the administrator enters device code 284. AP appliance 112 then transmits client ID 280, client secret 282, and device code 284 to cloud helper service 202 via API gateway 214.

Cloud helper service 202 compares the received client ID 280, client secret 282, and device code 284 to the information stored in authentication account mapping 290. If there is a match between each of the received client ID 280, client secret 282, and device code 284 to the information of authentication account mapping 290, and if device code 284 has not expired, cloud helper service 202 determines that it trusts AP appliance 112. This is because whichever entity transmitted device code 284 to cloud helper service 202 also possesses client ID 280 and client secret 282, which were transmitted to cloud helper service 202 earlier. Accordingly, if a fraud intercepted device code 284 from cloud helper service 202, that fraud would have also needed to possess client ID 280 and client secret 282.

Upon determining that AP appliance 112 is trusted, cloud helper service 202 requests cloud authentication service 200 to create an authentication account 292. Cloud authentication service 200 creates authentication account 292 to use client ID 280 and client secret 282 as credentials. Authentication account 292 is associated with permissions such as to acquire desired states from agent lifecycle orchestration service 204 and to download images of agents from agent repository 210. For example, authentication account 292 may use a protocol such as OAuth 2.0. Upon the creating of authentication account 292, AP appliance 112 may begin requesting access tokens from cloud authentication service 200. Such access tokens permit AP appliance 112 to communicate with cloud services of cloud platform 102, e.g., to install agents thereon.

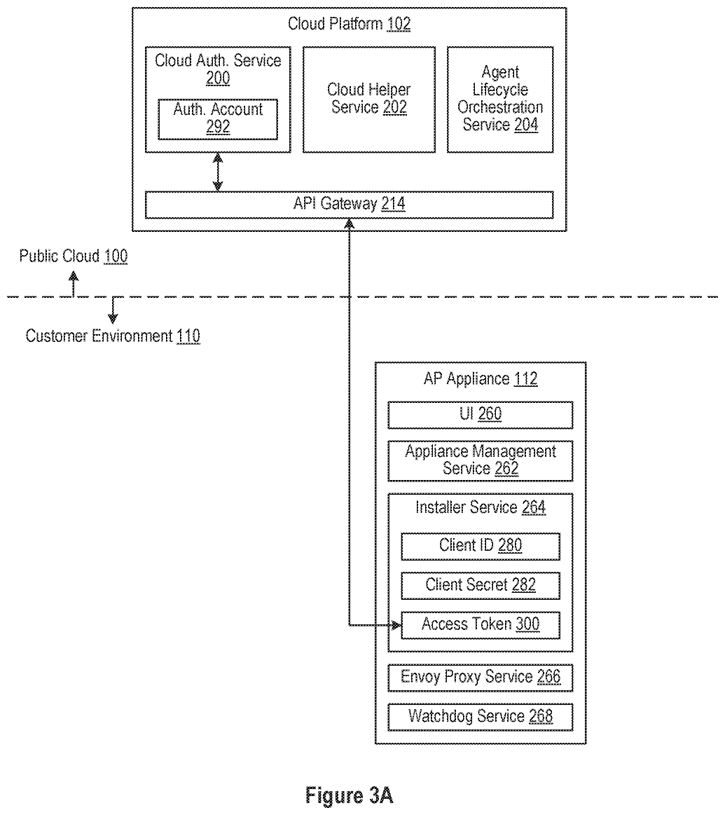

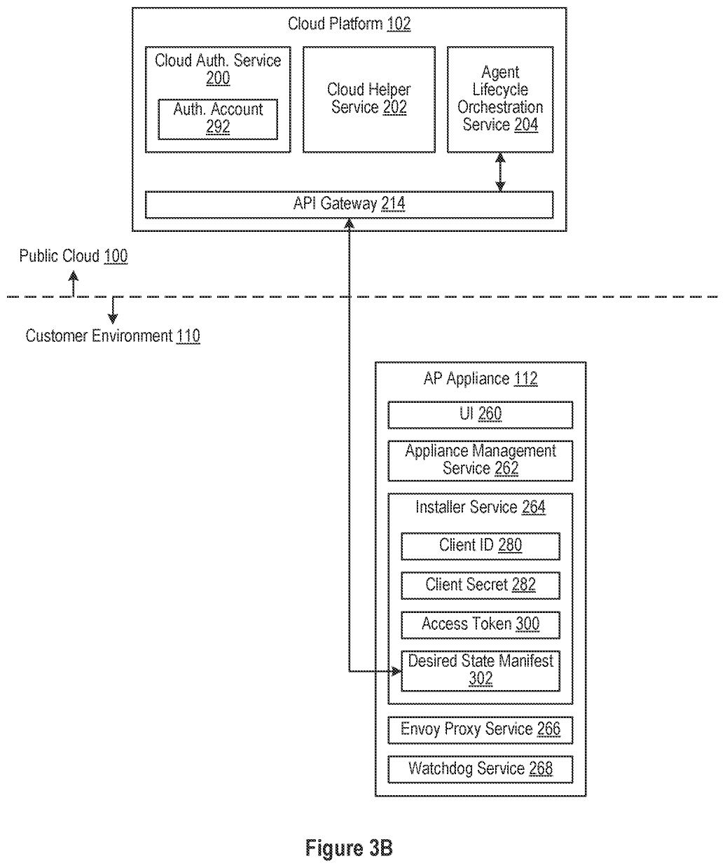

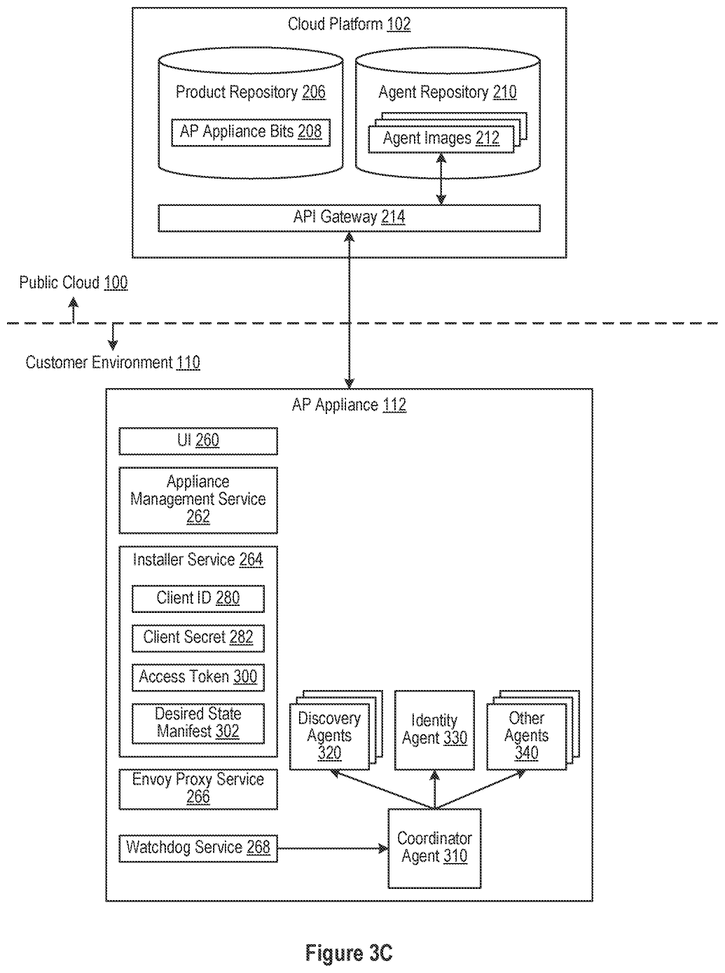

FIG. 3A is a block diagram of customer environment 110 and public cloud 100, illustrating a first step of deploying AP appliance 112. Installer service 264 transmits an API request to cloud authentication service 200 via API gateway 214 for an access token 300. The request includes client ID 280 and client secret 282 in an encrypted header of the request. Cloud authentication service 200 matches client ID 280 and client secret 282 to credentials of authentication account 292. Upon determining the match, cloud authentication service 200 transmits access token 300 to installer service 264 to be used thereby to complete the deployment of AP appliance 112.

FIG. 3B is a block diagram of customer environment 110 and public cloud 100, illustrating a second step of deploying AP appliance 112. Installer service 264 transmits an API request to agent lifecycle orchestration service 204 via API gateway 214 for a desired state of AP appliance 112. The request includes access token 300. In response to the request and upon verifying permissions of access token 300, agent lifecycle orchestration service 204 transmits a desired state manifest 302 to installer service 264. Desired state manifest 302 includes a list of agents to install on AP appliance 112.

FIG. 3C is a block diagram of customer environment 110 and public cloud 100, illustrating a final step of deploying AP appliance 112. Based on desired state manifest 302, installer service 264 determines to download an image of a coordinator agent 310. Installer service 264 thus transmits an API request to agent repository 210 for the image. The request includes access token 300. In response to the request and upon verifying permissions of access token 300, agent repository 210 transmits the image of coordinator agent 310 to installer service 264. Installer service 264 then transmits the image to watchdog service 268 via envoy proxy service 266 and instructs watchdog service 268 to install coordinator agent 310.

Envoy proxy service 266 is a service that forwards communications between services of AP appliance 112, between agents of AP appliance 112, and between services and agents. Watchdog service 268 is a service that installs coordinator agent 310 using the image thereof. Thereafter, watchdog service 268 continuously monitors coordinator agent 310. If coordinator agent 310 malfunctions, watchdog service 268 reinstalls coordinator agent 310 from an image thereof. Coordinator agent 310 is a service that installs other agents on AP appliance 112 and that manages the lifecycle and orchestration thereof.

Although not illustrated in FIG. 3C, upon installation of coordinator agent 310, coordinator agent 310 acquires an updated desired state manifest from agent lifecycle orchestration service 204 similarly to how installer service 264 acquired desired state manifest 302. Coordinator agent 310 determines from the updated desired state manifest to download images of various additional agents from agent repository 210. Coordinator agent 310 then downloads images of the additional agents from agent repository 210 similarly to how installer service 264 downloaded the image of coordinator agent 310.

Using the images thereof, coordinator agent 310 installs the additional agents, including discovery agents 320, an identity agent 330, and other agents 340. Discovery agents 320 manage communications with respective management appliances of SDDC 114-1. One of discovery agents 320 manages communications with VIM server appliance 250 for all of SDDCs 114, and others of discovery agents 320 manage communications with others of management appliances 116 of SDDCs 114. To manage such communications, discovery agents 320 store administrative credentials of respective management appliances for logging in to the respective management appliances and performing administrative operations.

Identity agent 330 acquires access tokens from cloud authentication service 200 on behalf of other agents 340. Accordingly, identity agent 330 is given access to client ID 280 and client secret 282, which identity agent 330 includes in requests to cloud authentication service 200 for access tokens. As discussed earlier, each access token has a specified TTL after which it expires. Accordingly, to continue enabling communications between agents and cloud services, identity agent 330 occasionally requests a new access token. Other agents 340 correspond to cloud services of cloud platform 102 such as the SDDC configuration service, the SDDC upgrade service, the SDDC monitoring service, and the SDDC inventory service. Other agents 340 issue commands to management appliances 116 and report results of operations to respective cloud services via API gateway 214. In one embodiment, each of the agents installed on AP appliance 112 is a microservice that is implemented as one or more container images executing in AP appliance 112.

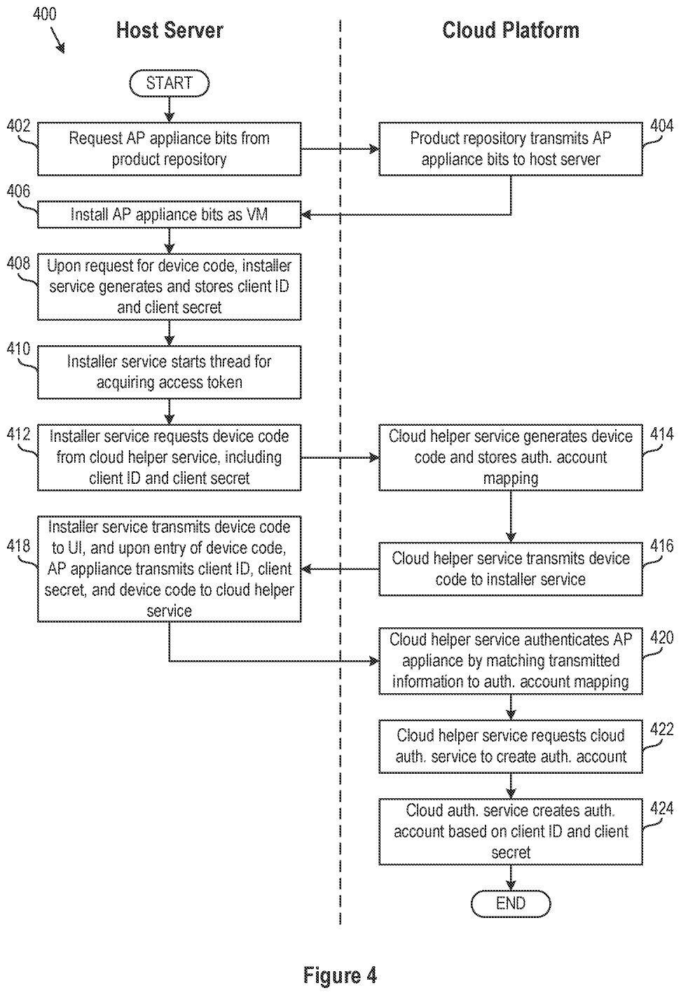

FIG. 4 is a flow diagram of a method 400 performed by one of host servers 220 and cloud platform 102 to register AP appliance 112 with cloud platform 102, according to an embodiment. At step 402, host server 220 requests AP appliance bits 208 from product repository 206. Host server 220 makes this request in response to the administrator selecting via an online portal of cloud platform 102, to download AP appliance bits 208 as an ISO file. At step 404, product repository 206 transmits AP appliance bits 208 to host server 220. At step 406, the administrator interacts with UI 260 to install AP appliance 112 from AP appliance bits 208. AP appliance 112 may be installed as a VM on host server 220, the installation including appliance management service 262 and installer service 264. Installer service 264 installs and starts envoy proxy service 266 and then watchdog service 268.

At step 408, appliance management service 262 generates a session ID and provides the session ID to UI 260 and installer service 264. UI 260 then transmits a request to installer service 264 for device code 284, which is to be used for authenticating with cloud platform 102. The request for device code 284 includes the session ID. Upon verifying the session ID, but before acquiring device code 284, installer service 264 randomly generates client ID 280 and client secret 282 according to predefined formats. Installer service 264 stores client ID 280 and client secret 282 in an encrypted file of host server 220.

At step 410, installer service 264 starts a thread for acquiring an access token. Periodically, this thread transmits a request to cloud authentication service 200 for the access token, the request including client ID 280 and client secret 282 in an authorization header. However, until an authorization account is created for AP appliance 112, such a request fails. At step 412, installer service 264 transmits an API request to cloud helper service 202 for device code 284. The request includes client ID 280 and client secret 282 as an encrypted header. At step 414, cloud helper service 202 generates device code 284 and stores authentication account mapping 290 in local memory of cloud helper service 202. Authentication account mapping 290 stores a mapping between device code 284, client ID 280, and client secret 282.

At step 416, cloud helper service 202 transmits device code 284 to installer service 264. At step 418, installer service 264 transmits device code 284 to UI 260. Upon the user entering device code 284 via a UI of cloud platform 102, AP appliance 112 transmits client ID 280, client secret 282, and device code 284 to cloud helper service 202. At step 420, cloud helper service 202 authenticates AP appliance 112, i.e., establishes trust with AP appliance 112. Specifically, cloud helper service 202 verifies that the information transmitted at step 418 matches the information stored in authentication account mapping 290, including client ID 280, client secret 282, and device code 284.

At step 422, cloud helper service 202 transmits a request to cloud authentication service 200 to create an authentication account for AP appliance 112. The request includes client ID 280 and client secret 282. At step 424, cloud authentication service 200 creates authentication account 292 based on client ID 280 and client secret 282, i.e., with client ID 280 and client secret 282 as credentials. Authentication account 292 is associated with permissions such as to acquire desired states from agent lifecycle orchestration service 204 and to download images of agents from agent repository 210. After step 424, method 400 ends.

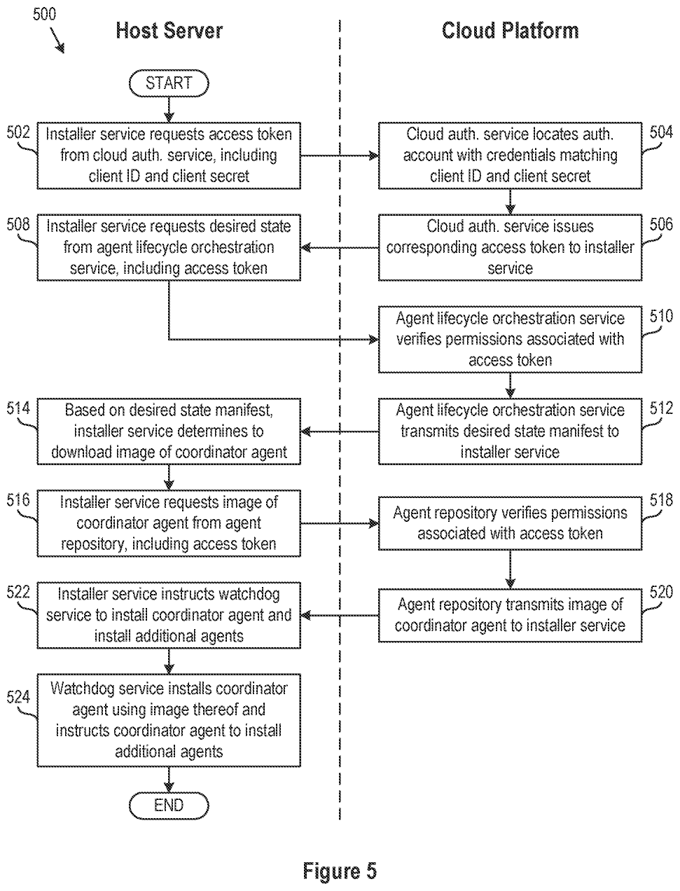

FIG. 5 is a flow diagram of a method 500 performed by host server 220 and cloud platform 102 to install coordinator agent 310 on AP appliance 112, according to an embodiment. Method 500 is performed after the registration of AP appliance 112 with cloud platform 102. At step 502, installer service 264 transmits an API request to cloud authentication service 200 for an access token. The request includes client ID 280 and client secret 282 as an encrypted header. Specifically, the request is transmitted by a thread of installer service 264 that was started upon the generation of client ID 280 and client secret 282, as discussed above. At step 504, cloud authentication service 200 locates authentication account 292, which uses client ID 280 and client secret 282 as credentials.

At step 506, cloud authentication service 200 issues to installer service 264, an access token corresponding to authentication account 292, i.e., embedded with permissions associated with authentication account 292. At step 508, installer service 264 transmits an API request to agent lifecycle orchestration service 204 for a desired state of AP appliance 112. The request includes the access token issued at step 506. At step 510, agent lifecycle orchestration service 204 verifies the permissions of the access token transmitted at step 508. At step 512, agent lifecycle orchestration service 204 transmits desired state manifest 302 to installer service 264, which includes a list of agents to install on AP appliance 112.

At step 514, installer service 264 determines from the list of agents of desired state manifest 302 to download an image of coordinator agent 310. At step 516, installer service 264 transmits an API request to agent repository 210 for the image of coordinator agent 310. The request includes the access token issued at step 506. At step 518, agent repository 210 verifies the permissions associated with the access token transmitted at step 516. At step 520, agent repository 210 transmits the image of coordinator agent 310 to installer service 264.

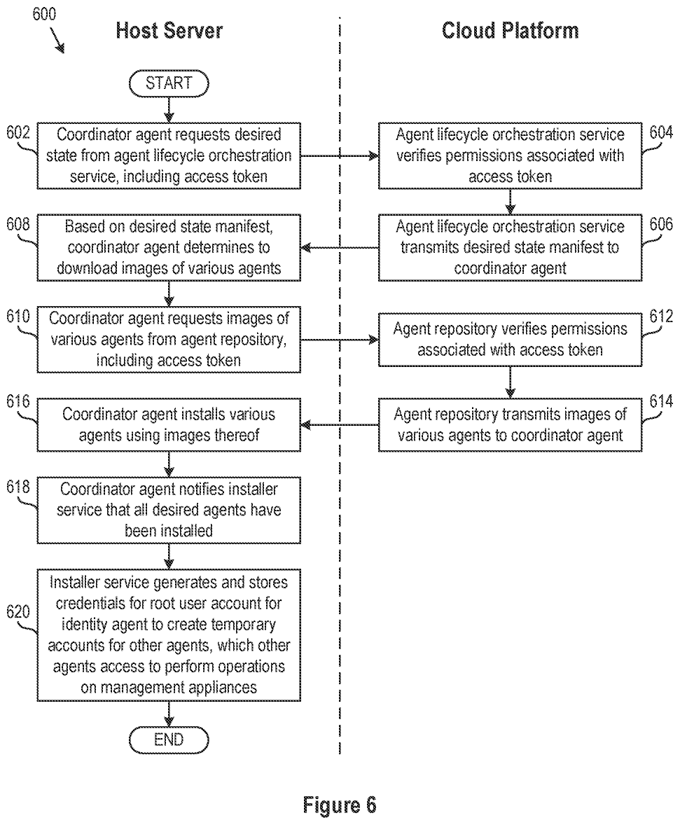

At step 522, installer service 264 instructs watchdog service 268 to install coordinator agent 310 and install additional agents. Installer service 264 transmits the image of coordinator agent 310 to watchdog service 268 via envoy proxy service 266. At step 524, watchdog service 268 installs coordinator agent 310 using the image thereof. Watchdog service 268 then instructs coordinator agent 310 to install additional agents. After step 524, method 500 ends, and coordinator agent 310 installs additional agents, as discussed now in conjunction with FIG. 6.

FIG. 6 is a flow diagram of a method 600 performed by host server 220 and cloud platform 102 to install additional agents on AP appliance 112, according to an embodiment. Method 600 is performed after watchdog service 268 installs coordinator agent 310. At step 602, coordinator agent 310 transmits an API request to agent lifecycle orchestration service 204 for a desired state of AP appliance 112. The request includes an access token previously acquired from cloud authentication service 200. At step 604, agent lifecycle orchestration service 204 verifies the permissions of the previously acquired access token. At step 606, agent lifecycle orchestration service 204 transmits an updated desired state manifest to coordinator agent 310, which includes a list of agents to install on AP appliance 112.

At step 608, coordinator agent 310 determines from the list of agents of the updated desired state manifest to download images of various agents. Specifically, coordinator agent 310 calculates drift between the desired state of AP appliance 112 and the actual state thereof. Based on the drift, coordinator agent 310 determines to download the images of the various agents. At step 610, coordinator agent 310 transmits an API request to agent repository 210 for the images of the various agents determined at step 608. The request includes the previously acquired access token. At step 612, agent repository 210 verifies the permissions associated with the previously acquired access token. At step 614, agent repository 210 transmits the images of the various agents to coordinator agent 310.

At step 616, coordinator agent 310 installs the various agents using the images thereof, e.g., discovery agents 320, identity agent 330, and other agents 340. At step 618, coordinator agent 310 transmits a notification to installer service 264 via envoy proxy service 266 that all desired agents have been installed on AP appliance 112. At step 620, installer service 264 generates and stores credentials for a root user account of AP appliance 112. The root user account is associated with permissions such as to create temporary accounts that further permit performing operations on management appliances such as VIM server appliance 250. The root user credentials are accessible to identity agent 330, and identity agent 330 accesses the root user account to create such temporary accounts for other agents installed on AP appliance 112.

The other agents use such local accounts to perform operations on the management appliances. Furthermore, identity agent 330, which has access to client secret 282 and a password of the root user account, periodically changes client secret 282 and the password of the root user account for security purposes. After step 620, method 600 ends, and AP appliance 112 has been deployed. Agents installed on AP appliance 112 may communicate with both management appliances of SDDCs and cloud services of cloud platform 102 to enable cloud platform 102 to deliver cloud-based services to the SDDCs.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are hard disk drives (HDDs), SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host server, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of registering and deploying an agent platform appliance in a hybrid environment, wherein the agent platform appliance connects management appliances of the hybrid environment to cloud services executing on a cloud platform of the hybrid environment, the method comprising:
transmitting a first code to the cloud platform to create an authentication account for the agent platform appliance, wherein credentials for accessing the authentication account include the first code;
transmitting a request for an access token that permits downloading images of agents from an agent repository of the cloud platform, wherein the request for the access token includes the first code for accessing the created authentication account;
upon receiving the access token, transmitting a request to the agent repository, to download the images of the agents, wherein the request to download the images of the agents includes the received access token; and
upon receiving the images of the agents from the agent repository, installing the agents on the agent platform appliance using the received images of the agents.

2. The method of claim 1, wherein the agent platform appliance is a virtual machine (VM) executing on a host server, and the installed agents are containers executing in the VM.

3. The method of claim 1, further comprising:
before the transmitting of the first code to the cloud platform, transmitting a request to a product repository of the cloud platform, for bits of the agent platform appliance, wherein the bits of the agent platform appliance include code for executing system services on the agent platform appliance; and
upon receiving the bits of the agent platform appliance, installing the system services on the agent platform appliance using the bits of the agent platform appliance.

4. The method of claim 1, further comprising:
before the transmitting of the first code to the cloud platform, generating the first code, wherein the first code is associated with an identifier of the agent platform appliance.

5. The method of claim 1, further comprising:
before the creating of the authentication account, transmitting a request to the cloud platform for a second code, wherein the second code is generated at the cloud platform; and
upon receiving the second code from the cloud platform, transmitting the second code to the cloud platform, wherein the cloud platform compares the second code transmitted to the cloud platform to the second code generated at the cloud platform to authenticate the agent platform appliance.

6. The method of claim 1, further comprising:
before the transmitting of the request to download the images of the agents, transmitting to the cloud platform a request for a desired state of the agent platform appliance, wherein the desired state of the agent platform appliance includes a list of the agents; and
upon receiving the desired state from the cloud platform, determining from the desired state to download the images of the agents from the agent repository.

7. The method of claim 1, further comprising:
generating credentials for a root user account of the agent platform appliance, wherein one of the installed agents accesses the root user account to create additional accounts for others of the installed agents, and the others of the installed agents access the additional accounts to perform operations on the management appliances.

8. A non-transitory computer-readable medium comprising instructions that are executable in a computer system of a hybrid environment, wherein the instructions when executed cause the computer system to carry out a method of registering and deploying an agent platform appliance in the hybrid environment, and wherein the agent platform appliance connects management appliances of the hybrid environment to cloud services executing on a cloud platform of the hybrid environment, the method comprising:
transmitting a first code to the cloud platform to create an authentication account for the agent platform appliance, wherein credentials for accessing the authentication account include the first code;
transmitting a request for an access token that permits downloading images of agents from an agent repository of the cloud platform, wherein the request for the access token includes the first code for accessing the created authentication account;
upon receiving the access token, transmitting a request to the agent repository, to download the images of the agents, wherein the request to download the images of the agents includes the received access token; and
upon receiving the images of the agents from the agent repository, installing the agents on the agent platform appliance using the received images of the agents.

9. The non-transitory computer-readable medium of claim 8, wherein the agent platform appliance is a virtual machine (VM) executing on a host server, and the installed agents are containers executing in the VM.

10. The non-transitory computer-readable medium of claim 8, the method further comprising:
before the transmitting of the first code to the cloud platform, transmitting a request to a product repository of the cloud platform, for bits of the agent platform appliance, wherein the bits of the agent platform appliance include code for executing system services on the agent platform appliance; and
upon receiving the bits of the agent platform appliance, installing the system services on the agent platform appliance using the bits of the agent platform appliance.

11. The non-transitory computer-readable medium of claim 8, the method further comprising:
before the transmitting of the first code to the cloud platform, generating the first code, wherein the first code is associated with an identifier of the agent platform appliance.

12. The non-transitory computer-readable medium of claim 8, the method further comprising:
before the creating of the authentication account, transmitting a request to the cloud platform for a second code, wherein the second code is generated at the cloud platform; and
upon receiving the second code from the cloud platform, transmitting the second code to the cloud platform, wherein the cloud platform compares the second code transmitted to the cloud platform to the second code generated at the cloud platform to authenticate the agent platform appliance.

13. The non-transitory computer-readable medium of claim 8, the method further comprising:
before the transmitting of the request to download the images of the agents, transmitting to the cloud platform a request for a desired state of the agent platform appliance, wherein the desired state of the agent platform appliance includes a list of the agents; and
upon receiving the desired state from the cloud platform, determining from the desired state to download the images of the agents from the agent repository.

14. The non-transitory computer-readable medium of claim 8, the method further comprising:
generating credentials for a root user account of the agent platform appliance, wherein one of the installed agents accesses the root user account to create additional accounts for others of the installed agents, and the others of the installed agents access the additional accounts to perform operations on the management appliances.

15. A computer system comprising a plurality of host servers of a hybrid environment, wherein the plurality of host servers includes an agent platform appliance that connects management appliances of the hybrid environment to cloud services executing on a cloud platform of the hybrid environment, and the agent platform appliance is configured to:
transmit a first code to the cloud platform to create an authentication account for the agent platform appliance, wherein credentials for accessing the authentication account include the first code;
transmit a request for an access token that permits downloading images of agents from an agent repository of the cloud platform, wherein the request for the access token includes the first code for accessing the created authentication account;
upon receiving the access token, transmit a request to the agent repository, to download the images of the agents, wherein the request to download the images of the agents includes the received access token; and
upon receiving the images of the agents from the agent repository, install the agents using the received images of the agents.

16. The computer system of claim 15, wherein the agent platform appliance is a virtual machine (VM) executing on one of the host servers, and the installed agents are containers executing in the VM.

17. The computer system of claim 15, wherein the agent platform appliance is further configured to:
before the transmitting of the first code to the cloud platform, generate the first code, wherein the first code is associated with an identifier of the agent platform appliance.

18. The computer system of claim 15, wherein the agent platform appliance is further configured to:
before the creating of the authentication account, transmit a request to the cloud platform for a second code, wherein the second code is generated at the cloud platform; and
upon receiving the second code from the cloud platform, transmit the second code to the cloud platform, wherein the cloud platform compares the second code transmitted to the cloud platform to the second code generated at the cloud platform to authenticate the agent platform appliance.

19. The computer system of claim 15, wherein the agent platform appliance is further configured to:
before the transmitting of the request to download the images of the agents, transmit to the cloud platform a request for a desired state of the agent platform appliance, wherein the desired state of the agent platform appliance includes a list of the agents; and
upon receiving the desired state from the cloud platform, determine from the desired state to download the images of the agents from the agent repository.

20. The computer system of claim 15, wherein the agent platform appliance is further configured to:
generate credentials for a root user account of the agent platform appliance, wherein one of the installed agents accesses the root user account to create additional accounts for others of the installed agents, and the others of the installed agents access the additional accounts to perform operations on the management appliances.
